(19) United States
(12) Patent Application Publication
(10) Pub. No.: US 2021/0402521 A1
(43) Pub. Date: Dec. 30, 2021

(54) LASER CUTTING DEVICE AND LASER CUTTING METHOD

(71) Applicant: WUHAN CHINA STAR OPTOELECTRONICS SEMICONDUCTOR DISPLAY TECHNOLOGY CO., LTD., WUHAN (CN)

(72) Inventor: ZHIMING LIN, WUHAN (CN)

(21) Appl. No.: 16/481,584

(22) PCT Filed: Feb. 21, 2019
(86) PCT No.: PCT/CN2019/075636

§ 371 Date: Jul. 29, 2019

(30) Foreign Application Priority Data
Nov. 7, 2018 (CN) 201811320929.7

(51) Int. Cl. B23K 26/361; B23K 26/03

(52) U.S. Cl. CPC B23K 26/361; B23K 26/032

(57) ABSTRACT

The present invention provides a laser cutting device and a laser cutting method. The laser cutting device of the present invention is used for cutting and removing scraps on a mask, includes a laser gun and a laser displacement. In use, the laser displacement senses whether presence of the scraps, and the laser gun cuts and removes the scraps according to a sensing result of the laser displacement. That is, the laser gun emits laser light to areas where the scraps are existent, and stops emitting the laser light to areas where the scraps are nonexistent. The invention combines the laser gun and the laser displacement, so that processes of setting cutting recipes according to different products before cutting can be omitted.

### FIELD OF INVENTION

The present invention relates to the field of display technologies, and in particular, to a laser cutting device and a laser cutting method for cutting a mask.

### BACKGROUND OF INVENTION

Organic light emitting diode (OLED) is a promising flat panel display technology with excellent display performance, especially because it has features such as self-illumination, simple structures, being ultra-thin, fast response times, wide viewing angles, low power consumption, and flexible display. Known as “Dream Displays,” coupled with its investment in production equipment being much less than thin film transistor (TFT) liquid crystal display (LCD), it has been favored by major display manufacturers, and has become the main force of the third-generation display devices in the display technology field. At present, OLEDs are on the eve of mass production. With further development of research and emergence of new technologies, OLED display devices will have breakthrough development.

The OLED has an anode, an organic light emitting layer, and a cathode which are sequentially formed on a substrate. In the preparation of the OLED display device, each layer of material in the OLED needs to be evaporated onto an array substrate by an evaporation process, and in the evaporation process, a corresponding fine metal mask (FMM) is required. The OLED materials are evaporated to a designed position through openings in the FMM. Specifically, by heating the OLED materials, the OLED materials are slowly changed into a gaseous sublimation, and then films are formed on the surface of the substrate through the openings of the FMM. The OLED display devices for color display are currently put into commercial production, mainly including RGB three-color OLED display devices and white light OLEDs with color filter (CF) display devices. Among them, RGB three-color OLED display devices are widely used in mobile display devices, and their FMM technology is the determining factor of display device resolution.

Usually, a mask consists of a mask frame and a mask sheet fixed by laser spot welding on the mask frame. The FMM sheet of a traditional FMM mask is mainly made of an invar material, which is fabricated by double-sided photolithography and etching. FIG. 1 is a schematic structural view of a conventional FMM. As shown in FIG. 1, in the prior art, a strip-shaped fine mask 200 having a plurality of pixel openings 210 is aligned with a metal frame 100 by a mask tension. Thereafter, they are welded together by laser, and then an integral FMM is applied to vapor deposition. In the FMM tension process, after the FMM sheet is finished, the original fine mask 200 is surrounded by scraps 205. In this case, the excess scraps 205 need to be cut by laser cutting.

The scraps of the FMM sheet are not in fixed areas. The areas of the scraps of different products are not the same. Therefore, an operator needs to set a recipe for the areas with the scraps and then set it in the system of the laser cutting device. The device cuts the specific areas containing the scraps according to the setting recipe. Because the process of setting the recipe is cumbersome and is easy to make mistakes, if an error occurs, the product is abnormal and the materials are wasted.

Therefore, it is necessary to design a new laser cutting device and laser cutting method to solve the above problems.

### SUMMARY OF INVENTION

An object of the present invention is to provide a laser cutting device which combines a laser gun and a laser displacement, thereby eliminating the need to set different recipes according to different products before cutting, thereby effectively avoiding quality anomalies and material waste.

The object of the present invention is further to provide a laser cutting method, which eliminates the process of setting cutting recipes according to different products before cutting, thereby effectively avoiding quality anomalies and material waste.

In order to achieve the above object, the present invention provides a laser cutting device, which is used for cutting and removing scraps on a mask. The laser cutting device comprises: a laser gun and a laser displacement that are arranged parallel to each other, and

the laser displacement sensing whether presence of the scraps, and the laser gun cutting and removing the scraps according to a sensing result of the laser displacement.

The laser displacement has a sensing port; and

the laser displacement emits laser light to the mask, and the sensing port receives laser light reflected by the mask to measure a distance between the sensing port and the mask, and perceive the presence of the scraps by comparing the measured distance to a set value.

A relative positional relationship between the laser gun and the laser displacement is fixed.

An energy density of laser light emitted by the laser displacement is less than an energy density of laser light emitted by the laser gun.

The laser cutting device further includes a control system that controls activation and deactivation of the laser gun and laser displacement.

The present invention further provides a laser cutting method, which is used for cutting and removing scraps on a mask, the laser cutting method comprising the following steps:

Step S1, providing the mask to be cut and a laser cutting device;

wherein the mask has scraps to be cut and removed, and the laser cutting device comprises a laser gun and a laser displacement which are arranged parallel to each other; and

step S2, placing the mask under the laser gun and the laser displacement, turning on the laser displacement to sense whether a presence of scraps by the laser displacement, wherein the laser gun cuts and removes the scraps according to a sensing result of the laser displacement by emitting laser light to areas where the scraps are existent for cutting the scraps, and the laser gun stops emitting the laser light to areas where the scraps are nonexistent.

The laser displacement includes a sensing port;

in step S2, the laser displacement emits laser light to the mask, and the sensing port receives laser light reflected by the mask to measure the distance between the sensing port and the mask, and perceive the presence of the scraps by comparing the measured distance to a set value.

In step S2, a relative positional relationship between the laser gun and the laser displacement is fixed.

In step S2, an energy density of the laser light emitted by the laser displacement is less than an energy density of laser light emitted by the laser gun.

The laser cutting device provided in step S1 further includes a control system that controls activation and deactivation of the laser gun and the laser displacement; and

step S1 further includes: setting a moving path of the laser displacement in the control system of the laser cutting device; in step S2, the laser displacement senses whether presence of the scraps on the moving path.

The beneficial effects of the invention: The laser cutting device of the present invention, which is used for cutting and removing scraps on a mask, comprises a laser gun and a laser displacement. In use, the laser displacement senses whether presence of the scraps, and the laser gun cuts and removes the scraps according to the sensing result of the laser displacement. That is, the laser gun emits laser light to areas where the scraps are existent, and stops emitting the laser light to areas where the scraps are nonexistent. The invention combines the laser gun and the laser displacement, so that processes of setting cutting recipes according to different products before cutting can be omitted. This can avoid setting error-prone items in the recipe processes, avoid the phenomenon that glasses that should be cut off by the recipe editing are not cut, glasses that should not be cut are damaged by the laser gun, or even the downtime occurs, thereby avoiding quality anomalies and material waste. The laser cutting method of the present invention, which is used in the above laser cutting device, can omit processes of setting cutting recipes according to different products before cutting, avoid the phenomenon that glasses that should be cut off by the recipe editing are not cut, glasses that should not be cut are damaged by the laser gun, or even the downtime occurs, thereby avoiding quality anomalies and material waste.

In order to further understand the features and technical details of the present invention, please refer to the following detailed description and drawings regarding the present invention. The drawings are provided for reference and description only and are not intended to limit the present invention.

### DESCRIPTION OF DRAWINGS

The technical solutions and other advantageous effects of the present invention will be apparent from the following detailed description of embodiments of the invention.

In the drawings,

FIG. 1 is a schematic structural view of a fine mask after a mask tension process;

FIG. 2 is a side view showing a structure of a laser cutting device of the present invention;

FIG. 3 is a schematic top plan view of the laser cutting device of the present invention;

FIG. 4 is a schematic view showing a process of sensing scraps of the laser cutting device of the present invention;

FIG. 5 is a schematic view showing a cutting process of the scraps of the laser cutting device of the present invention; and

FIG. 6 is a schematic flow chart of a laser cutting method of the present invention.

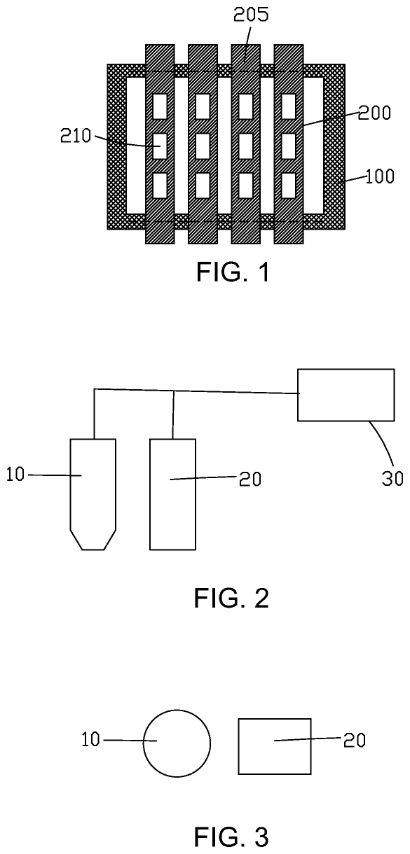

### DETAILED DESCRIPTION OF PREFERRED EMBODIMENTS

In order to further clarify the technical means and effects of the present invention, the following detailed description will be made in conjunction with the preferred embodiments of the invention and the accompanying drawings.

The present invention first provides a laser cutting device for cutting and removing scraps 95 on a mask 90. As shown in FIGS. 2-3, the laser cutting device includes a laser gun 10 and a laser displacement 20 that are arranged parallel to each other, a working platform (not shown) disposed under the laser gun 10 and the laser displacement 20, and a control system 30 that controls activation and deactivation of the laser gun 10 and laser displacement 20.

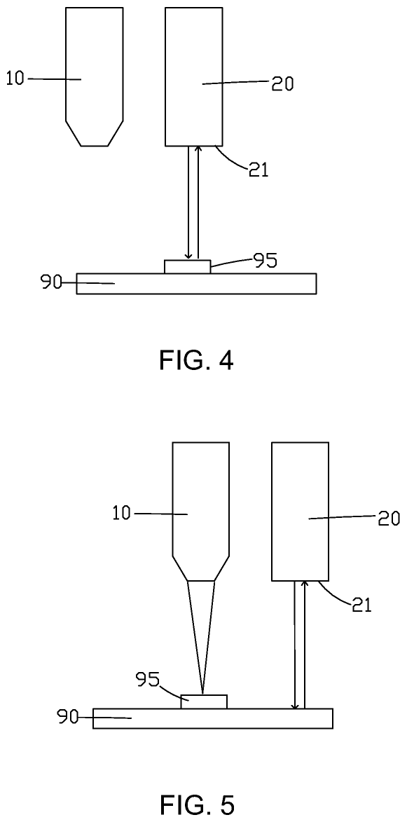

The laser displacement 20 is configured to sense whether presence of the scraps 95 on a moving path, and the laser gun 10 can cut and remove the scraps 95 according to a sensing result of the laser displacement 20. In use, as shown in FIGS. 4-5, the laser displacement 20 senses whether the presence of the scraps 95 on the moving path, and the laser gun 10 cuts and removes the scraps 95 according to the sensing result of the laser displacement 20. That is, the laser gun 10 emits laser light to areas where the scraps 95 are existent, and stops emitting the laser light to areas where the scraps 95 are nonexistent.

Specifically, the laser gun 10 is a Nd:YAG (neodymium-doped yttrium aluminum garnet; Nd:Y₃Al₅O₁₂) laser, which is a solid state laser that emits a laser of 1064 nm for cutting metal materials.

Specifically, the laser displacement 20 is a laser displacement that emits a laser having a wavelength of 655 nm.

Specifically, the laser displacement 20 has a sensing port 21. In use, the laser displacement 20 emits the laser light to the mask, and the sensing port 21 receives laser light reflected by the mask 90 to measure a distance between the sensing port 21 and the mask 90, and perceives the presence of the scraps 95 by comparing the measured distance to a set value, for example, by comparing the measured distance with the distance between the sensing port 21 and the mask 90 when there is no scrap.

Specifically, an energy density of the laser light emitted by the laser displacement 20 is less than an energy density of the laser light emitted by the laser gun 10.

Specifically, a relative positional relationship between the laser gun 10 and the laser displacement 20 is fixed. That is, during the debugging of the laser cutting device, the relative position between the laser gun 10 and the laser displacement 20 can be obtained through testing. The lateral distance between the laser gun 10 and the laser displacement 20 is DX, the longitudinal distance between the laser gun 10 and the laser displacement 20 is DY, and the tested DX and DY are then input into the control system 30 of the laser cutting device. Then, when the laser gun 10 cuts and removes the scraps 95 according to the sensing result of the laser displacement 20, the control system 30 modifies the cutting path of the laser gun 10 according to the inputted DX and DY, and all subsequent products can directly follow this setting.

The laser cutting device of the present invention is used for cutting and removing scraps 95 on a mask 90, includes a laser gun 10 and a laser displacement 20. In use, the laser displacement 20 senses whether presence of the scraps 95, and the laser gun 10 cuts and removes the scraps 95 according to the sensing result of the laser displacement 20. That is, the laser gun 10 emits laser light to areas where the scraps 95 are existent for cutting, and the laser gun 10 stops emitting the laser light to areas where the scraps are nonexistent. The invention combines the laser gun 10 and the laser displacement 20, so that processes of setting cutting recipes according to different products before cutting can be omitted. This can avoid setting error-prone items in the recipe processes, avoid the phenomenon that glasses that should be cut off by the recipe editing are not cut, glasses that should not be cut are damaged by the laser gun 10, or even the downtime occurs, thereby avoiding quality anomalies and material waste.

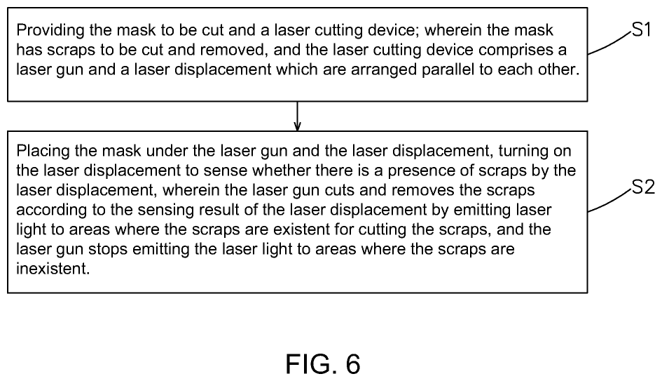

Referring to FIG. 6, based on the above laser cutting device, the present invention further provides a laser cutting method for cutting and removing scraps 95 on the mask 90. The laser cutting method comprises the following steps:

Step S1, providing a mask 90 to be cut and a laser cutting device.

Specifically, the mask 90 has scraps 95 to be cut and removed. The laser cutting device includes a laser gun 10 and a laser displacement 20 which are arranged parallel to each other, a working platform is disposed under the laser gun 10 and the laser displacement 20 (not shown), and a control system 30 that controls activation and deactivation of the laser gun 10 and laser displacement 20.

Specifically, the step S1 further includes: setting a moving path of the laser displacement 20 in the control system 30 of the laser cutting device.

Step S2, placing the mask 90 on the working platform below the laser gun 10 and the laser displacement 20, and turning on the laser displacement 20. The laser displacement 20 senses whether presence of the scraps 95 on the moving path, and the laser gun 10 cuts and removes the scraps 95 according to a sensing result of the laser displacement 20. That is, the laser gun 10 emits laser light to areas where the scraps 95 are existent for cutting, and the laser gun 10 stops emitting the laser light to areas where the scraps 95 are nonexistent.

It should be noted that the moving path of the laser displacement 20 is not set by the product category. The moving path can be shared by different products, and thus it is not required to be reset when the product is replaced. Compared with the existing process, which is necessary to set a specific cutting recipe for each product, it saves manpower and material resources.

Specifically, the laser displacement 20 has a sensing port 21. In step S2, the laser displacement 20 emits the laser light to the mask, and the sensing port 21 receives laser light reflected by the mask 90 to measure the distance between the sensing port 21 and the mask 90, and perceive the presence of the scraps 95 by comparing the measured distance to a set value.

Specifically, in step S2, a relative positional relationship between the laser gun 10 and the laser displacement 20 is fixed. That is, during the debugging of the laser cutting device, the relative position between the laser gun 10 and the laser displacement 20 can be obtained through testing. The lateral distance between the laser gun 10 and the laser displacement 20 is DX, the longitudinal distance between the laser gun 10 and the laser displacement 20 is DY, and the tested DX and DY are then input into the control system 30 of the laser cutting device. Then, when the laser gun 10 cuts and removes the scraps 95 according to the sensing result of the laser displacement 20, the control system 30 modifies the cutting path of the laser gun 10 according to the inputted DX and DY, and all subsequent products can directly follow this setting.

Specifically, in step S2, an energy density of the laser light emitted by the laser displacement 20 is less than an energy density of the laser light emitted by the laser gun 10.

The laser cutting method of the invention adopts the above-mentioned laser cutting device, and thus can omit processes of setting cutting recipes according to different products before cutting, avoid the phenomenon that glasses that should be cut off by the recipe editing are not cut, glasses that should not be cut are damaged by the laser gun, or even the downtime occurs, thereby avoiding quality anomalies and material waste.

In summary, the laser cutting device of the present invention, which is used for cutting and removing the scraps on the mask, comprises the laser gun and the laser displacement. In use, the laser displacement senses whether presence of the scraps, and the laser gun cuts and removes the scraps according to the sensing result of the laser displacement. That is, the laser gun emits the laser light to the areas where the scraps are existent, and stops emitting the laser light to the areas where the scraps are nonexistent. The invention combines the laser gun and the laser displacement, so that processes of setting cutting recipes according to different products before cutting can be omitted. This can avoid setting error-prone items in the recipe processes, avoid the phenomenon that glasses that should be cut off by the recipe editing are not cut, glasses that should not be cut are damaged by the laser gun, or even the downtime occurs, thereby avoiding quality anomalies and material waste. The laser cutting method of the present invention, which is used in the above laser cutting device, can omit processes of setting cutting recipes according to different products before cutting, avoid the phenomenon that glasses that should be cut off by the recipe editing are not cut, glasses that should not be cut are damaged by the laser gun, or even the downtime occurs, thereby avoiding quality anomalies and material waste.

In the above, various other corresponding changes and modifications can be made according to the technical solutions and technical ideas of the present invention to those skilled in the art, and all such changes and modifications are within the scope of the claims of the present invention.

What is claimed is:

1. A laser cutting device, which is used for cutting and removing scraps on a mask, the laser cutting device comprising a laser gun and a laser displacement that are arranged parallel to each other, and
the laser displacement sensing whether presence of the scraps, and the laser gun cutting and removing the scraps according to a sensing result of the laser displacement.

2. The laser cutting device as claimed in claim 1, wherein the laser displacement has a sensing port;
the laser displacement emits laser light to the mask, and the sensing port receives laser light reflected by the mask to measure a distance between the sensing port and the mask, and perceive the presence of the scraps by comparing the measured distance to a set value.

3. The laser cutting device as claimed in claim 1, wherein a relative positional relationship between the laser gun and the laser displacement is fixed.

4. The laser cutting device as claimed in claim 1, wherein an energy density of laser light emitted by the laser displacement is less than an energy density of laser light emitted by the laser gun.

5. The laser cutting device as claimed in claim 1, further including a control system that controls activation and deactivation of the laser gun and laser displacement.

6. A laser cutting method, which is used for cutting and removing scraps on a mask, the laser cutting method comprising the following steps:
step S1, providing the mask to be cut and a laser cutting device;
wherein the mask has scraps to be cut and removed, and the laser cutting device comprises a laser gun and a laser displacement which are arranged parallel to each other;
step S2, placing the mask under the laser gun and the laser displacement, turning on the laser displacement to sense presence of scraps by the laser displacement, wherein the laser gun cuts and removes the scraps according to a sensing result of the laser displacement by emitting laser light to areas where the scraps are existent for cutting the scraps, and the laser gun stops emitting the laser light to areas where the scraps are nonexistent.

7. The laser cutting method as claimed in claim 6, wherein the laser displacement includes a sensing port;
in step S2, the laser displacement emits the laser light to the mask, and the sensing port receives laser light reflected by the mask to measure the distance between the sensing port and the mask, and perceive the presence of the scraps by comparing the measured distance to a set value.

8. The laser cutting method as claimed in claim 6, wherein in step S2, a relative positional relationship between the laser gun and the laser displacement is fixed.

9. The laser cutting method as claimed in claim 6, wherein in step S2, an energy density of the laser light emitted by the laser displacement is less than an energy density of laser light emitted by the laser gun.

10. The laser cutting method as claimed in claim 6, wherein the laser cutting device provided in step S1 further includes a control system that controls activation and deactivation of the laser gun and the laser displacement; and
step S1 further includes: setting a moving path of the laser displacement in the control system of the laser cutting device; in step S2, the laser displacement senses whether there are scraps on the moving path.
